(19) United States
(12) Patent Application Publication
(10) Pub. No.: US 2017/0283959 A1
(43) Pub. Date: Oct. 5, 2017

(54) METHOD FOR CLEANING ARTICLES USING NONFLAMMABLE, AZEOTROPIC OR AZEOTROPE-LIKE COMPOSITION

(71) Applicants: Dov SHELLEF, Rhinebeck, NY (US); Edo SHELLEF, Flower Mound, TX (US)

(72) Inventors: Dov SHELLEF, Rhinebeck, NY (US); Edo SHELLEF, Flower Mound, TX (US)

(21) Appl. No.: 15/477,658

(22) Filed: Apr. 3, 2017

Related U.S. Application Data
(60) Provisional application No. 62/317,948, filed on Apr. 4, 2016.

(51) Int. Cl. C23G 5/032; C09K 3/00; C11D 7/50

(52) U.S. Cl. CPC C23G 5/032; C11D 7/5077; C09K 3/00

(57) ABSTRACT

A nonflammable solvent composition, a method of cleaning an article, and a method of depositing a material on a substrate are disclosed. The nonflammable solvent composition includes a fluorocyclopentane in which 3 to 9 hydrogen atoms have each been replaced by a fluorine atom; trans-1,2-dichloroethylene (t-DCE); and at least one organic compound, such as a C₂-C₆ alcohol, a C₁-C₆ alkane, and a C₃-C₆ cycloalkane. Amounts of the fluorocyclopentane, t-DCE, and the organic compound in the nonflammable composition are selected so that the composition is an azeotrope or is azeotrope-like. The method of cleaning an article includes contacting the article with the nonflammable composition via vapor degreasing or wet cleaning. The method of depositing a material on a substrate includes dissolving the material in the nonflammable solvent composition, applying the composition containing the material to the substrate, and evaporating the composition from the substrate.

This application claims the benefit of U.S. Provisional Application No. 62/317,948, filed Apr. 4, 2016. The disclosure of the prior application is hereby incorporated by reference herein in its entirety.

### BACKGROUND

Cleaning of products and parts of products to remove contaminants, such as waxes, greases, oils, and solder flux residues, is an integral part of many manufacturing, maintenance, and refurbishing operations. Many metallic articles or components are treated with oil or other processing agents during the fabrication process and it is frequently required that this oil and any other contaminants must be removed before the article is ready for use or sale, or before the component is installed into the finished product. Additionally, contaminants, such as excess rosin flux, must often be removed from electronic or electrical components or devices, such as circuit boards, before they are acceptable for use because the presence of such contaminants could interfere with the performance of the electrical or electronic components and could also damage the components. Solvent cleaning processes, such as vapor degreasing and wet cleaning, can be used to remove contaminants from such articles and parts.

Solvent compositions have been significantly restricted over the past couple of decades due to environmental and safety concerns. For example, it is generally preferred that solvent compositions have low toxicity, little global warming potential, low to no volatile organic compounds (VOCs), and produce low to no hazardous air pollutants. Further, when solvent compositions are used for wet cleaning of articles, such as electronic or electrical components or metal parts, or for vapor degreasing of articles, it is preferred that such solvent compositions are nonflammable, fast drying, and exhibit high dissolving capabilities so that the solvents do not harm the components.

In many cleaning applications, there is a concern relating to potential fire or explosion hazards because many solvent compositions are flammable or contain flammable solvents that are, for example, mixed with other nonflammable solvents. For example, the use of non-azeotropic mixtures containing flammable solvents in vapor degreasing can be very dangerous because flammable compositions can develop in one or more portions of the vapor degreasing apparatus as the cleaning process proceeds. Similarly, wet cleaning of electronic or electrical components and/or devices using a flammable composition can also be dangerous because of the danger of generating a spark. However, many formulations that exhibit lower flammability or are nonflammable may not have sufficiently aggressive cleaning characteristics, and as a result are not very practical for use as in cleaning applications.

A need thus exists for a method of cleaning articles using a nonflammable solvent composition that has a lower environmental impact, while simultaneously having sufficiently aggressive cleaning characteristics.

### SUMMARY

Disclosed herein is a nonflammable solvent composition, a method of cleaning an article, and a method of depositing a material on a substrate. The nonflammable solvent composition includes a fluorocyclopentane in which 3 to 9 hydrogen atoms have each been replaced by a fluorine atom; trans-1,2-dichloroethylene (t-DCE); and at least one organic compound, such as a C₂-C₆ alcohol, a C₁-C₆ alkane, and a C₃-C₆ cycloalkane. Amounts of the fluorocyclopentane, t-DCE, and the organic compound in the nonflammable composition are selected so that the composition is an azeotrope or is azeotrope-like.

The method of cleaning an article includes contacting the article with the nonflammable composition via vapor degreasing or wet cleaning. The article may be contacted with the nonflammable composition via wet cleaning, for example, when the article is an electrical or electronic device or component to avoid the danger of fire or an explosion, for example, when the device is connected to a power source, such as an alternating current (AC) power source or a battery.

The method of depositing a material on a substrate includes dissolving the material in the nonflammable solvent composition, applying the composition containing the material to the substrate, and evaporating the composition from the substrate.

### DETAILED DESCRIPTION OF EMBODIMENTS

Disclosed herein are a nonflammable solvent composition and a method of cleaning using the nonflammable solvent composition. The composition includes trans-1,2-dichloroethylene (t-DCE), fluorocyclopentane, and at least one other organic compound. For example, the organic compound may be an alcohol, alkane, or cycloalkane. The solvent composition is azeotropic or azeotrope-like and can be used in solvent cleaning, including, for example, vapor degreasing, wet cleaning, and ultrasonic cleaning of an article, such as complex metal parts, electronic or electrical components such as circuit boards, implantable prosthetic devices, optical equipment, and others. A method of cleaning an article by contacting the article with the composition via wet cleaning or vapor degreasing, and recovering the article from the composition is also disclosed herein. The article may be contacted with the nonflammable composition via wet cleaning, for example, when the article is an electrical or electronic device or component to avoid the danger of fire or an explosion, for example, when the device is connected to a power source, such as an alternating current (AC) power source or a battery. A method of depositing a material on a substrate is also disclosed herein. The method includes dissolving the material in the nonflammable solvent composition, applying the solvent composition containing the material to a substrate, and evaporating the solvent composition from the substrate.

### Nonflammable Azeotropic or Azeotrope-Like Composition

As used herein, “azeotrope” and “azeotropic composition” refer to an admixture of two or more substances in which the admixture distills without substantial composition change and behaves as a constant boiling composition. Constant boiling compositions, which are characterized as azeotropic, exhibit either a maximum or a minimum boiling point, as compared with that of the non-azeotropic mixtures of the same substances. Azeotropic compositions as used herein include homogeneous azeotropes, which are liquid admixtures of two or more substances that behave as a single substance, in that the vapor, produced by partial evaporation or distillation of the liquid, has the same composition as the liquid. Azeotropic compositions as used herein also include heterogeneous azeotropes where the liquid phase splits into two or more liquid phases. In these embodiments, at the azeotropic point, the vapor phase is in equilibrium with two liquid phases and all three phases have different compositions. If the two equilibrium liquid phases of a heterogeneous azeotrope are combined and the composition of the overall liquid phase calculated, this would be identical to the composition of the vapor phase.

As used herein, the term “azeotrope-like composition,” also sometimes referred to as “near azeotropic composition,” means a constant boiling, or substantially constant boiling liquid admixture of two or more substances that behaves as a single substance. One way to characterize an azeotrope-like composition is that the vapor produced by partial evaporation or distillation of the liquid has substantially the same composition as the liquid from which it was evaporated or distilled. That is, the admixture distills/refluxes without substantial composition change. For example, the total compositional change between the vapor and the liquid after the admixture distills/refluxes is about 10% or less, or about 5% or less. Another way to characterize an azeotrope-like composition is that the bubble point vapor pressure of the composition and the dew point vapor pressure of the composition at a particular temperature are substantially the same. For example, a composition is azeotrope-like if, after 50 wt. % of the composition is removed, such as by evaporation or boiling off, the difference in vapor pressure between the original composition and the composition remaining after 50 wt.% of the original composition has been removed by evaporation or boiling off is less than about 10%.

An azeotropic or azeotrope-like composition, by definition, must include at least two components. The most common azeotropic systems are binary azeotropes and contain two components. Ternary azeotropes contain three components. Azeotropes of four or more components also exist. Disclosed herein are azeotrope or azeotrope-like compositions of at least three components. For example, the composition may be a ternary azeotropic or azeotrope-like composition, which contains three components, or a quaternary azeotropic or azeotrope-like composition, which contains four components.

It follows from the above that azeotropic and azeotrope-like compositions encompass a range of compositions containing the same components in varying proportions, all of which are azeotropic or azeotrope-like. For example, the concentration of an azeotrope will vary relative to the pressure of the system. A person skilled in the art of distillation understands that changing the pressure of the system will change the concentration of each component of the azeotrope. All such compositions are intended to be covered by the term “azeotrope” or “azeotrope-like” as used herein.

If compound A forms an azeotrope with a second compound, compound B, it would be expected that all isomers of compound A will also form an azeotrope with compound B. For example, xylene will form an azeotrope with n-butyl alcohol. As such, it would be expected that all three isomers of xylene, namely, o-, m-, and p-xylene, will for an azeotrope with n-butyl alcohol.

One way to determine if a mixture is an azeotrope or azeotrope-like is through fractional distillation. Multiple steps of evaporation and condensation of a mixture can be performed via a fractional distillation column. Such a system is designed to separate a mixture of liquid substances into individual, pure substances based on differences in their boiling points. If the mixture does not separate by fractional distillation, it is azeotropic or azeotrope-like. Analyzing the distilled fractions from a fractional distillation column can identify the concentrations of the azeotropic or azeotrope-like mixture.

A fractional distillation column can also be used to accurately determine the boiling point of the azeotrope. If a maximum or minimum temperature is reached relative to the individual substances, an azeotrope or azeotrope-like composition is present.

The azeotropic or azeotrope-like compositions can possess the properties needed for de-fluxing, de-greasing applications, and other cleaning applications. The inherent invariance of the compositions under boiling conditions insures that the ratios of the individual components of the mixture will not change substantially during use and that solvency properties will remain constant as well.

The azeotropic and azeotrope-like compositions are thus useful in cleaning, defluxing, and degreasing processes. The present compositions are nonflammable, and as they do not fractionate, will not produce flammable compositions during use. Additionally, the used azeotropic or azeotrope-like solvent mixtures may be re-distilled and re-used without substantial composition change.

As used herein, the term, “nonflammable,” refers to, e.g., the absence of a flash point up to the boiling point of the composition at standard atmospheric pressure as determined in accordance with ASTM D56, or alternatively, satisfaction of the criteria for nonflammability as set forth in ASTM D3065 if the composition is delivered via aerosol.

As used herein, the term “flash point” refers to the lowest temperature at which a material can vaporize to form an ignitable mixture in air.

As used herein, the modifier “about” used in connection with a quantity is inclusive of the stated value and has the meaning dictated by the context. For example, it includes at least the degree of error associated with the measurement of the particular quantity. When used in the context of a range, the modifier “about” should also be considered as disclosing the range defined by the absolute values of the two endpoints. For example, the range “from about 2 to about 4” also discloses the range “from 2 to 4.”

In some embodiments, the composition is a nonflammable, ternary azeotrope or azeotrope-like composition that contains t-DCE, a fluorocyclopentane, and another organic compound.

As used herein, “trans-1,2-dichloroethylene” or “t-DCE” refers to, e.g., the trans isomer of an organochloride with the molecular formula, C₂H₂Cl₂. T-DCE is a highly flammable solvent, but has exceptional cleaning power and a lower toxicity compared to equivalent chlorinated solvents, such as trichloroethylene, tetrachloroethylene, and methylene dichloride. Despite the high flammability of t-DCE, it has been surprising to discover that the present composition is nonflammable even when it contains relatively large amounts of t-DCE.

Unless otherwise indicated, the amounts disclosed herein for any of the substances or solvent components included in the composition are based on a total weight of the composition. The present composition may include t-DCE in an amount in a range of from about 30 wt. % to about 99 wt. %. For example, the solvent composition may include t-DCE in an amount in a range of from: about 40 wt. % to about 96 wt. %, about 60 wt. % to about 94 wt. %, about 70 wt. % to about 92 wt. %, about 75 wt. % to about 90 wt. %, about 78 wt. % to about 88 wt. %, and about 78 wt. % to about 86 wt. %, based on a total weight of the composition.

The solvent composition may further include a fluorocyclopentane. Cyclopentane is an alicyclic hydrocarbon with chemical formula C₅H₁₀, having a ring of five carbon atoms each bonded with two hydrogen atoms above and below the plane. As used herein, “fluorocyclopentane” refers to a cyclopentane in which one or more of the hydrogen atoms have been each replaced by a fluorine atom. The present composition may contain a fluorocyclopentane in which 1 to 9 hydrogen atoms have been each substituted with a fluorine atom. For example, the fluorocyclopentane may have 3 to 9 hydrogen atoms that have each been be substituted with a fluorine atom, or 6 to 8 hydrogen atoms that have each been substituted by a fluorine atom. In one embodiment, the fluorocyclopentane may be 1,1,2,2,3,3,4-heptafluorocyclopentane (“HFCP”), with chemical formula C₅H₃F₇.

The composition may include t-DCE, fluorocyclopentane, and an organic compound in effective amounts to form a ternary azeotrope or azeotrope-like composition, or the composition may include t-DCE, fluorocyclopentane, and two additional organic compounds in effective amounts to form, for example, a quaternary azeotrope or azeotropic-like composition.

The composition may include a fluorocyclopentane in an amount in a range of from about 2 wt. % to about 50 wt. %, about 5 wt. % to about 40 wt. %, about 5 wt. % to about 30 wt. %, about 9 wt. % to about 25 wt. %, about 10 wt. % to about 20 wt. %, or about 12 wt. % to about 20 wt. %, based on a total weight of the composition.

The composition may further include at least one other organic compound. The organic compound may be one or more of an alcohol, alkane, or cycloalkane. For example, the organic compound may be a C₂ to C₆ alcohol, such as ethanol, 1-propanol, 2-propanol, 1-butanol, 2-butanol, isobutanol, tert-butanol, amyl alcohol, isoamyl alcohol, 2-methyl-1-butanol, neopentanol, 3-pentanol, 2-pentanol, 3-methyl-2-butanol, tert-amyl alcohol, 1-hexanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2,-dimethyl-1-butanol, 2,3-dimethyl-1-butanol, 3,3-dimethyl-1-butanol, 2,3-dimethyl-2-butanol, 3,3-dimethyl-2-buanol, and 2-ethyl-1-butanol. In some embodiments the organic compound is one or more of ethanol, 1-propanol, and 2-propanol. The at least one organic compound may be a C₁ to C₆ alkane, such as methane, ethane, propane, butane, pentane, or hexane, or a C₃ to C₆ cycloalkane, such as cyclopropane, cyclobutane, cyclopentane, or cyclohexane. For example, in some embodiments, the organic compound may be one or more of ethanol, 1-propanol, 2-propanol, hexane, and cyclohexane. Even though many of these organic compounds are flammable, and t-DCE is flammable, the resulting composition is nonflammable.

The composition may include t-DCE, fluorocyclopentane, and an organic compound in effective amounts to form a ternary azeotrope or azeotrope-like composition. The composition may include the organic compound in an amount in a range of from about 0.1 wt. % to about 15 wt. %, about 0.2 wt. % to about 13 wt. %, about 0.3 wt. % to about 12 wt. %, about 0.5 wt. % to about 10 wt. %, about 1 wt. % to about 9 wt. %, about 2 wt. % to about 7 wt. %, and about 0.1 wt. % to about 5 wt. %, based on a total weight of the composition.

In some embodiments, the composition includes t-DCE in an amount in a range of from about 30 to about 99 wt. %; the fluorocyclopentane in an amount in a range of from about 2 to about 50 wt. %; and one of ethanol, 1- or 2-propanol, hexane, or cyclohexane in an amount in a range of from about 0.1 to about 15 wt. %, based on a total weight of the composition. In these embodiments, the composition boils at a temperature in a range of from about 40° C. to about 50° C., or about 42° C. to about 47° C. at 760 mmHg.

In some embodiments, the composition includes t-DCE in an amount in a range of from 60 to 92 wt. %, HFCP in an amount in a range of from 9 to 20 wt. %, and ethanol in an amount in a range of from 2 to 9 wt. %, based on a total weight of the composition. In these embodiments, the composition may boil at a temperature of about 46° C.

The solvent composition, which includes a range of concentrations of the various solvent components, can be formulated to have varying degrees of aggressiveness, while at the same time, maintaining nonflammability characteristics. For example, t-DCE exhibits strongly aggressive solvent cleaning properties, but is flammable. The fluorocyclopentane exhibits relatively good solvent properties and is nonflammable, but generally lacks the aggressiveness of t-DCE. Therefore, the composition can be formulated such that the aggressive tendencies of t-DCE are tempered by the combination of t-DCE with, for example, the fluorocylopentane and at least one organic compound, and the solvent composition as formulated is acceptable for use in essentially all of the electrical, electromechanical, mechanical, and other applications disclosed herein. The unique combination of solvent components provides a composition in which the aggressiveness of the solvent composition can be varied to suit a desired application, all while maintaining nonflammability characteristics. Despite the flammability of t-DCE and, possibly, the at least one organic compound, the resulting composition is nonflammable.

### Additives

The composition may also optionally contain other components that do not materially affect the composition's non-flammability or its exceptional cleaning power. For example, the present composition may also contain one or more additives, such as stabilizers, inhibitors, surfactants, and antioxidants, some of which may form new azeotrope-like compositions. Such additives typically are added at the expense of the other components and in amounts known to one skilled in the art. The total amount of such additives may be in an amount of up to about 10 wt. % based on the total weight of the composition or up to about 5 wt. % based on the total weight of the composition. More specifically, these optional components may be present in an amount of about 0.01 wt. % to about 5 wt. %, about 0.1 wt. % to about 3 wt. %, or about 0.1 wt. % to about 1 wt. % based on a total weight of the composition. In some embodiments, the total amount of additives may be present in the composition in an amount of up to about 10 wt. % or up to about 5 wt. % based on the total weight of the remainder of the composition.

For example, stabilizers may be added to the present composition. Stabilizers are typically added to solvent compositions to inhibit decomposition of the compositions, and/or prevent corrosion of metal surfaces. Stabilizers react with undesirable decomposition products of the compositions. Any combination of conventional stabilizers known to be useful for stabilizing halogenated hydrocarbon solvents may be used in the present composition. Suitable stabilizers include, for example, alkanols having 4 to 7 carbon atoms, nitroalkanes having 1 to 3 carbon atoms, 1,2-epoxyalkanes having 2 to 7 carbon atoms, phosphite esters having 12 to 30 carbon atoms, ethers having 3 or 4 carbon atoms, unsaturated compounds having 4 to 6 carbon atoms, acetals having 4 to 7 carbon atoms, ketones having 3 to 5 carbon atoms, and amines having 6 to 8 carbon atoms. Other suitable stabilizers are readily known by those skilled in the art.

Additionally, various known alcohols and other solvents may also be included in the composition in small quantities, such as of about 0.01 wt. % to about 5 wt. %, about 0.1 wt. % to about 3 wt. %, or about 0.1 wt. % to about 1 wt. % based on the total weight of the composition. Known alcohols and solvents that may be added in small amounts to the present composition include methanol, ethanol, isopropanol, n-butanol, isooctanol, methyl isobutyl carbinol, isoamyl alcohol, isobutyl alcohol, tert butyl alcohol, cyclohexanol, methyl cyclohexanol, benzyl alcohol, benzoic acid, furfuryl alcohol, and the like.

In addition, minor amounts of surfactants can also be included. Typical surfactants useful in the composition may include ionic and non-ionic surface active agents, for example, sulfonate salts, phosphate salts, carboxylate salts, fatty acids, alkyl phenols, glycols, esters and amides. Surface active agents also include ionic and non-ionic water displacement compounds, such as tetra-alkyl ammonium sulfonate, phosphate, and carboxylate and bromide salts, aliphatic amino alkanols, fluorinated amino alkanols, and chlorofluorinated amino alkanols.

### Methods of Preparing the Composition

The present compositions may be prepared by admixing effective amounts of a fluorocyclopentane, t-DCE, and at least one other organic compound, such as ethanol, 1- or 2-propanol, hexane, or cyclohexane, to provide the desired azeotropic or azeotrope-like cleaning solvent composition. The order of addition of the components is not critical. When desired, one or more other components or additives may be optionally added.

### Methods of Cleaning

Disclosed herein are methods of cleaning an article using the azeotropic or azeotrope-like compositions. The method of cleaning an article includes contacting the article with the composition, and recovering the article from the composition. The method of cleaning reduces the level of contaminants on the article. Therefore, the recovered article is substantially free of contaminants and is also substantially free of residue from the cleaning composition.

The term, “article” as used herein refers to any device, article of manufacture, product, part, component, substrate, or any portion or surface of any such device, article of manufacture, product, part, component, or substrate that may be subject to contamination by unwanted materials. Thus, the term “article” broadly encompasses, for example, machine parts, tools, component assemblies, complex metal parts, implantable prosthetic devices, electrical and electronic components, switches, circuits, boards, printed circuit boards, semiconductor chips, magnetic media, disk drive heads, avionics, connectors, relays and contacts, solenoids, motor and motor windings, circuit breakers, circuit breaker panels, transformers, electrical and data communication connectors and switching devices, electronic controls, timers, cable assemblies, splices and terminations, hydraulic and pneumatic equipment, optical equipment, fiber optics, metal or metal oxide products, glass products, plastics, elastomers, photographic and movie film, molds for casting plastics, surfaces being prepared for painting, fabrics, animal hides, ceramics, stone or stone-like materials such as concrete, wood, natural fibers, synthetic fibers, PVC pipes, optical lenses, polymeric substrates, and the like, and any portion or surface thereof. The article may be connected to a power source, such as an AC power source, a battery, or the like.

As used herein, “electronic device,” “electrical device,” or “electronic or electrical device” refers to an entire device or any part, component, surface, or portion thereof. Wet cleaning may be performed on such a device even when it is connected to a power source.

The term, “contaminant” is likewise used in a broad sense to designate any unwanted material or substance present on the article, even if the material or substance was placed on the article intentionally. For example, circuit boards, commonly used in electronic appliances, such as televisions and computers, are often contaminated with solder flux in the assembly process. Solder flux is a grease-like substance that is either applied to the surface of the board before soldering, or is contained in the core of the solder itself, in order to help the solder retain heat and spread onto a surface. This sticky flux residue must then be removed from the surface of the circuit board. Non-limiting examples of “contaminant” include flux (e.g., solder flux), grease, wax, oil, polymer, lubricant, dirt, lint, dust, particulate matter, corrosive materials, oxidation products, residue, and the like. For example, the composition may be used to remove relatively heavy motor oil and lighter weight oils, such as machine oils or other light-weight lubricants, such as silicone or Teflon® polytetrafluoroethylene (PTFE).

The composition may be used to clean electronic or electrical devices or components, such as integrated circuits or silicon chips. For example, it is necessary to clean silicon chips are manufacturing simply to remove any possible contamination, as these delicate parts must be absolutely clean to perform properly.

The contacting of the article with the composition may be performed in a variety of ways. In some embodiments, the contacting is performed via wet cleaning or vapor degreasing. The wet cleaning can be performed on, for example, electronic or electrical components or devices. These electronic or electrical components or devices may be connected to a power source.

The contacting step may be performed in any suitable apparatus or vessel, including, for example, in a reaction vessel, sump, vat, dip tank, autoclave, vapor degreaser, or the like, and may be conducted while open or closed to the atmosphere. In some embodiments, the contacting need not be performed in an apparatus or vessel at all.

The wet cleaning may be performed via a parts washer, any batch loaded, non-boiling degreaser, sprays, aerosols, and the like. For example, the wet cleaning may involve spraying the composition onto the article, flushing the article with the composition, wiping the article with an absorbent medium containing the composition, or immersing the article in the composition. In some embodiments, the composition is sprayed onto the surface of the article. The composition may be sprayed in the form of a liquid or an aerosol. For example, a jet stream of the present composition may be sprayed onto the article. The composition may be sprayed onto the article from a trigger bottle or pump sprayer. The surface of the article can be brushed or wiped before, during, or after spraying the composition onto the surface of the article. For example, the article may be brushed or wiped to assist in cleaning, particularly if the article contains an excessive amount of contaminants. Such brush or wiping can be effective in enhancing penetration of the contaminants by the solvent composition.

In some embodiments, the composition may be sprayed onto the surface as an aerosol. In such embodiments, the composition may be combined with a propellant to create an aerosol, such as nitrogen, carbon dioxide, difluoromethane, trifluoromethane, 1,3,3,3-tetrafluoropropene (HFO-1234ze), and fluorinated ethanes, such as 1,1,1,2-tetrafluoroethane (HFE-134a). Both the HFC-134a propellant and the HFO-1234ze propellant typically allow for uniform spray until the aerosol is emptied. Furthermore, both HFC-134a and HFO-1234ze are nonflammable propellants. These propellants are highly beneficial because of their nonflammability and low or no VOC properties. Further, HFO-1234ze has zero ozone-depletion potential and has low global warming potential. Additional propellants, including flammable propellants, nonflammable propellants, VOC free propellants, and VOC containing propellants, may be used, however, without departing from the spirit and the scope of the present invention. Furthermore, the flammable properties of traditionally flammable propellants, such as butane and propane, may be reduced or eliminated when used in connection with the present composition. The propellant may be present in the aerosol in an amount of about 3 to about 50 wt. % based on a total weight of the aerosol.

The aerosol may be inserted into an aerosol container capable of spraying the aerosol and/or mixed with boron nitride powder and/or other compatible powder additives, such as metal powders, to create an aerosol mixture. The aerosol spray container, such as an aerosol can, can be used to spray the aerosol onto the surface of the article.

In some embodiments, wet cleaning may involve fully or partially immersing or soaking the article in the composition with or without agitation. For example, the wet cleaning may be performed by contacting the article in a sump, vat, dip tank, or the like containing the solvent composition. The article can be optionally subjected to ultrasonic agitation, or contacted with a jet stream of the solvent composition. In one aspect, the solvent composition is sprayed onto the article prior to degreasing, such as vapor degreasing.

Ultrasonics may be used in conjunction with the wet cleaning for removing at least one of water or water-soluble contaminants from, for example, deep recesses or inaccessible areas.

The wet cleaning may include contacting the surface of the article with an absorbent medium containing the composition. The absorbent medium may be, for example, a cloth, swab, paper, or brush saturated with the composition. The surface of the article may be wiped, rubbed, or brushed with the absorbent medium. For example, when the absorbent medium is a cloth, the article may be wiped with the cloth to wet clean the article.

The wet cleaning may be performed at a temperature in a range of about 10° C. to about 47° C., such as about 15° C. to about 30° C., about 20° C. to about 26° C., or about ambient or room temperature. In some embodiments, the wet cleaning is performed on an electronic or electrical component or device at about ambient temperature. Methods of wet cleaning electronic or electrical components or devices using the present nonflammable composition are advantageous in that they can minimize or reduce the danger of a fire during the cleaning, particularly for electronic/electrical components that are connected to power sources and/or where the power remains on during cleaning.

In some embodiments, the contacting may be performed via vapor degreasing. Vapor degreasing can be performed in an open or closed vapor degreasing apparatus. It is contemplated that numerous varieties and types of vapor degreasing equipment are adaptable for use in connection with the present methods. For example, the equipment may include a boiling sump for containing the cleaning composition, a clean sump for containing the distilled cleaning composition, a water separator, and any other ancillary equipment.

In some embodiments, vapor degreasing may be performed by heating or boiling the composition to vaporize the composition, and exposing the article to vapors of the composition. For example, the liquid solvent composition may be heated in a reservoir to vaporize the composition. The vapors of the composition can condense on the surface of the article during exposure of the article to the vapors. The surface of the article can be relatively cold compared to the relatively hot vapor. The condensed vapors can then solvate or entrain one or more contaminates on the surface of the article. The contaminated solvent (i.e., the condensed solvent containing the dissolved contaminants) can then be drained into the reservoir, for example, by falling from the article into the reservoir under the influence of gravity. The reservoir can be the same reservoir containing the liquid solvent composition that is being heated to vaporize the composition. The liquid solvent composition can be vaporized continuously to form a vapor blanket comprising the composition. Because only the solvent composition is vaporized (and not the contaminants), the contaminants remain in the reservoir, for example, in the form of a sludge. The article can therefore be continuously flushed with the non-contaminated solvent composition.

The contacting of the vapor with the article in some embodiments creates a scrubbing action as the vapor condenses on the article. The article can be maintained in contact with the vapor composition for a period of time to raise the temperature of the article to about the temperature of the vapor, whereupon condensation substantially ceases and the article appears dry. The article can then be removed from the degreaser. The time required to cause cessation of the condensation process varies depending upon numerous factors, including the particular solvent composition employed, the temperature of the vapor, the weight of the article, its specific heat, and the type of contamination material to be removed.

The vapor degreasing can be beneficially used in some embodiments to contact the surface of the article, as well as penetrate any holes, cracks, or crevices of the article, so as to remove contaminants therefrom.

Another type of vapor degreasing is referred to as vapor-spray cycle degreasing. In vapor-spray cycle degreasing, the article to be cleansed is first placed in a vapor zone, as is done in the above-described vapor degreasing process. A portion of the vapor is condensed by use of cooling coils and fills a liquid solvent reservoir. Warm liquid solvent is pumped through a spray nozzle which sprays it directly onto the part to be degreased, thus washing off contaminants and cooling the article.

In some embodiments, the vapor phase degreasing may be liquid-vapor cycle degreasing. In liquid-vapor cycle degreasing, a first compartment contains a refluxing solvent and a second compartment contains a somewhat cooler solvent condensate, which is referred to as the rinse sump. A vapor zone is maintained over the refluxing solvent. In this type of degreasing operation, the article to be cleaned is first suspended in the vapor zone until condensation of vapor on the article ceases. Next, the article is lowered into the refluxing solvent in the first compartment. After a suitable period of time, the article is removed to the rinse sump. Finally, the parts are again placed in the vapor zone until dry. This type of degreasing may be particularly useful for heavily soiled articles or for cleaning a basket or container of small parts that are nested together.

In some embodiments, the vapor phase degreasing is ultrasonic degreasing. Ultrasonic degreasing can be useful for cleaning critical parts and typically uses a transducer that is mounted at the base of a solvent tank and operates in the range of 20 to 40 kHz. The transducer alternately compresses and expands the solvent composition, thereby forming small bubbles that, in turn, cavitate or collapse on the surface of the article. This cavitation phenomenon disrupts the adhering contaminants, thereby cleaning the article.

Because vapor degreasing operations generally involve the use of a heat source in relatively close proximity to the degreasing solvents in both liquid and vapor states, it is highly beneficial to use a solvent composition that remains nonflammable through all parts of the degreasing process/apparatus in order to minimize or reduce the danger of fire or explosion. Similarly, it is highly recommended to use a nonflammable composition for cleaning electronic or electrical components or devices to minimize or reduce the danger of the component or device catching fire.

The present compositions are nonflammable despite a content of t-DCE that is per se flammable. Unexpectedly, even compositions that further contain a flammable organic compound, such as ethanol, 1- or 2-propanol, hexane, or cyclohexane, are nonflammable. The methods of cleaning, particularly wet cleaning of an electrical or electronic component or device, or vapor degreasing of an article using the present composition is highly advantageous at least because it reduces the risk of fire or an explosion.

Another advantage of the present methods of cleaning using the nonflammable composition is that precautions against the hazard of flammability or explosion need not be taken. Further, there is no need to label storage tanks containing the composition with signs or warnings against those risks.

Yet another advantage of using the present composition in a vapor degreasing process is that, because the composition is an azeotrope or azeotrope-like, both the distillate and residue do not have substantial changes in composition. Therefore, the composition is not shifted into a flammable range during vapor degreasing. Further, even after partial distillation, the composition of both the residue and of the distillate retain the composition's properties, for example, its ability to degrease, dewater, and solubilize contaminants.

The article may be recovered from the composition by evaporation of the composition, draining the composition off the surface, or wiping or brushing the composition off the surface. For example, the solvent composition along with the solvated contaminants may be removed from the surface of the article by wiping it away, such as with a cloth or other material, or by letting the solvent composition run off into a pan or other collection device. In some embodiments, the surface of the article is recovered from the composition by allowing the composition to evaporate, for example, due to the natural evaporation tendencies of the composition. The present composition is nonflammable and can evaporate quickly. In some embodiments, the composition can evaporate at ambient or room temperature. Alternatively, the article may be heated to facilitate evaporation of the composition. For example, the article may be contacted with a jet stream of warm air to facilitate evaporation of the composition.

Use of the present composition is advantageous because substantially no residue from the composition itself remains on the surface after cleaning. Not only might residue interfere with the performance of the article, for example, an electrical or electronic component, but it could also damage the article. The present composition advantageously leaves substantially no residue, while simultaneously being strong enough to tackle tenacious contaminants. As a result of the methods of cleaning disclosed herein, one or more contaminants are removed from the article, for example, by being dissolved in the composition.

### Other Methods of Using the Composition

Other non-limiting examples of uses for the present azeotropic or azeotrope-like compositions include their use as solvents for refrigeration flushing; in oxygen system cleaning; in foam blowing, in paints, in adhesives, in lubricants, and in systems for depositing a material onto a substrate, for example to deposit silicone fluids on hypodermic needles, to deposit lubricating oils in very small and inaccessible places, to deposit paints and varnishes, and to deposit glues.

The methods of depositing a material onto a substrate may involve using the composition as a carrier solvent in applications including, for example, lubricants, penetrants, coatings, and surface protectants. For example, a material may be deposited on a substrate by dissolving the material in the present nonflammable composition, applying the composition containing the material onto the substrate, and evaporating the composition such that the material remains on the substrate. Materials may include, for example, polymers, waxes, oils, silicone fluids, other lubricants, paints, pesticides, insecticides, and fungicides.

More specifically, the composition may be used for dissolving materials, and for removing these materials from, and/or delivering these materials to a surface. For example, after the composition dissolves one or more materials, these materials may be reconstituted on any number of surfaces for the purpose of providing a coating.

A material or substance may be dissolved in the present nonflammable composition. Then, this liquid is applied to a substrate by dipping, brushing, or spraying, including aerosol spraying. Next, the present composition is evaporated from the substrate by heating, or by the natural evaporation tendencies of the composition. The material or substance is then left behind on the substrate in an even, thorough coating.

The present compositions and methods offer several advantages over existing methods. The methods and compositions, as well as their advantages, will be described in greater detail by way of specific examples. The following examples are offered for illustrative purposes, and are not intended to limit nor define the invention in any manner.

### EXAMPLES

The range over which the following compositions exhibit constant boiling behavior was determined using fractional distillation. A 45 mm mirrored-vacuum-jacketed distillation column packed with Raschig rings equipped with a cold-water condenser and an automatic liquid dividing head were used to confirm the composition of azeotropic compositions. The distillation column was charged with the solvent mixture and the resulting composition was heated under total reflux for about a half an hour to ensure equilibration. A reflux ratio of 5:1 was employed to remove the distillate fraction. The compositions of the overhead fractions were analyzed using Gas Chromatography and are reported in the tables below.

Physical properties of exemplary components of the present composition are set forth in Table I. Exemplary azeotropes are set forth in Table II below. These azeotropes are nonflammable. Tables III-V provide exemplary azeotropic and azeotrope-like compositions. The numerical ranges are understood to be prefaced by “about.”

TABLE I
Physical Properties

| Solvent | Boiling Point (° C.) |
|---|---|
| HFPC | 82 |
| t-DCE | 48 |
| Ethanol | 78 |
| 1-Propanol | 97 |
| 2-Propanol | 82 |
| Hexanes | 69 |
| Cyclohexane | 81 |

TABLE II
Azeotropes Identified

| Component | | | BP | weight % | | |
|---|---|---|---|---|---|---|
| A | B | C | (° C.) | A | B | C |
| HFCP | t-DCE | Ethanol | 46.0 | 12.0 | 83 | 5.0 |
| HFCP | t-DCE | 1-Propanol | 46.6 | 17.2 | 82.7 | 0.1 |
| HFCP | t-DCE | 2-Propanol | 46.3 | 16.2 | 83.4 | 0.4 |
| HFCP | t-DCE | Hexanes | 46.7 | 18.5 | 78.3 | 3.2 |
| HFCP | t-DCE | Cyclohexane | 46.5 | 19.7 | 79.6 | 0.7 |

TABLE III
Exemplary Compositions

| Component | | | BP | weight % | | |
|---|---|---|---|---|---|---|
| A | B | C | (° C.) | A | B | C |
| HFCP | t-DCE | Ethanol | 46.0 | 5-30 | 50-95 | 0.1-12 |
| HFCP | t-DCE | 1-Propanol | 46.6 | 2-50 | 30-99 | 0.1-12 |
| HFCP | t-DCE | 2-Propanol | 46.3 | 2-50 | 30-99 | 0.1-13 |
| HFCP | t-DCE | Hexanes | 46.7 | 2-50 | 30-99 | 0.1-15 |
| HFCP | t-DCE | Cyclohexane | 46.5 | 2-50 | 30-99 | 0.1-15 |

TABLE IV
Exemplary Compositions

| Component | | | BP | weight % | | |
|---|---|---|---|---|---|---|
| A | B | C | (° C.) | A | B | C |
| HFCP | t-DCE | Ethanol | 46.0 | 5-30 | 50-95 | 1-12 |
| HFCP | t-DCE | 1-Propanol | 46.6 | 5-40 | 40-96 | 0.2-9 |
| HFCP | t-DCE | 2-Propanol | 46.3 | 5-40 | 40-96 | 0.2-9 |
| HFCP | t-DCE | hexanes | 46.7 | 2-50 | 30-99 | 1-12 |
| HFCP | t-DCE | cyclohexane | 46.5 | 2-50 | 30-99 | 0.2-10 |

TABLE V
Exemplary Compositions

| Component | | | BP | weight % | | |
|---|---|---|---|---|---|---|
| A | B | C | (° C.) | A | B | C |
| HFCP | t-DCE | Ethanol | 46.0 | 9-20 | 60-92 | 2-9 |
| HFCP | t-DCE | 1-Propanol | 46.6 | 10-30 | 50-94 | 0.3-6 |
| HFCP | t-DCE | 2-Propanol | 46.3 | 10-30 | 50-94 | 0.3-6 |
| HFCP | t-DCE | hexanes | 46.7 | 10-30 | 50-94 | 2-9 |
| HFCP | t-DCE | Cyclohexane | 46.5 | 10-30 | 50-94 | 0.5-7 |

The nonflammability of the azeotropic and azeotrope-like compositions is surprising because about 80 wt. % or more of the composition may contain flammable components (e.g., t-DCE, ethanol, 1- or 2-propanol, hexane, and cyclohexane). Thus, one might predict that the entire composition would be flammable. Additionally, when methanol (which has a boiling point of 64° C.) is used as the organic compound (C), the composition is flammable. This is demonstrated in Table VI below.

TABLE VI
Comparative Example

| Component | | | BP | weight % | | | Flash point |
|---|---|---|---|---|---|---|---|
| A | B | C | (° C.) | A | B | C | (° C.) |
| HFCP | t-DCE | Methanol | 41.7 | 11.0 | 86 | 3.0 | 27 |

Table VI demonstrates that even when only a small amount of methanol, such as 3.0 wt. %, is used, the composition exhibits a flash point at 27° C. Thus, it is unexpected that the present composition is nonflammable when the organic compound (C) is, for example, ethanol, 1- or 2-propanol, hexane, or cyclohexane, all of which are known to be flammable, if not highly flammable. It is particularly surprising that these compounds can be used as the organic compound (C) at higher amounts, for example, up to 15 wt. %, without rendering the composition flammable. In particular, as shown in Table II, ethanol can be used in an amount of about 5 wt. % to form an azeotropic composition that is nonflammable.

The nonflammability of the present composition enables the composition to be used in a broader array of applications, particularly those where nonflammability is critical. For example, the present composition can be used to clean articles via vapor degreasing processes, as well as wet cleaning of electronic components and devices, as discussed in more detail above. It is critical that the compositions used in these processes be nonflammable avoid or reduce the danger of a fire or explosion during the cleaning process.

Although only a few example embodiments have been described in detail above, those skilled in the art will readily appreciate that many modifications are possible in the example embodiments without materially departing from the methods of cleaning and nonflammable composition. Accordingly, all such modifications are intended to be included within the scope of this disclosure as defined in the following claims.

What is claimed is:

1. A method of cleaning an article comprising:
contacting the article with a nonflammable composition via vapor degreasing or wet cleaning;
wherein
the nonflammable composition comprises:
a fluorocyclopentane in which 3 to 9 hydrogen atoms have each been replaced by a fluorine atom;
trans-1,2-dichloroethylene (t-DCE); and
at least one organic compound selected from the group consisting of a C₂-C₆ alcohol, a C₁-C₆ alkane, and a C₃-C₆ cycloalkane; and
amounts of the fluorocyclopentane, t-DCE, and the organic compound in the nonflammable composition are selected so that the composition is an azeotrope or is azeotrope-like.

2. The method according to claim 1, wherein the vapor degreasing is performed by:
heating the composition to vaporize the composition; and
exposing the article to vapors of the composition.

3. The method according to claim 2, wherein the vapors of the composition condense on the article during exposure of the article to the vapors.

4. The method according to claim 3, wherein the condensed vapors dissolve one or more contaminates on the article.

5. The method according to claim 1, wherein the wet cleaning comprises spraying the composition onto the article.

6. The method according to claim 5, wherein the composition is sprayed in the form of a liquid or an aerosol.

7. The method according to claim 5, further comprising brushing the article during or after spraying the composition onto the article.

8. The method according to claim 1, wherein the wet cleaning comprises immersing the article in the composition.

9. The method according to claim 1, wherein the wet cleaning comprises contacting the article with an absorbent medium containing the composition.

10. The method according to claim 1, further comprising removing the composition from the article by one or more selected from the group consisting of:
evaporating the composition, draining the composition off the article, wiping the composition off the article, and brushing the composition off the article.

11. The method according to claim 1, wherein the wet cleaning is performed at a temperature in a range of from 10° C. to 47° C.

12. The method according to claim 1, wherein the wet cleaning is performed at ambient temperature.

13. The method of claim 1, wherein:
before contacting the article with the composition, the article has one or more contaminants selected from the group consisting of a polymer, grease, oil, wax, dirt, and lubricant; and
the one or more contaminants are removed upon contacting the article with the composition.

14. The method according to claim 1, wherein the article is a metal part when wet cleaning is used.

15. The method according to claim 1, wherein
the fluorocyclopentane is 1,1,2,2,3,3,4-heptafluorocyclopentane (HFCP); and
the organic compound is selected from the group consisting of ethanol, 1-propranol, 2-propanol, hexane, and cyclohexane.

16. The method according to claim 15, wherein the organic compound is ethanol.

17. The method according to claim 1, wherein the article is an electronic or electrical device connected to a power source when wet cleaning is used.

18. The method according to claim 1, wherein the composition is azeotropic.

19. A nonflammable solvent composition comprising:
a fluorocyclopentane in which 3 to 9 hydrogen atoms have each been replaced by a fluorine atom;
trans-1,2-dichloroethylene (t-DCE); and
at least one organic compound selected from the group consisting of a C₂-C₆ alcohol, a C₁-C₆ alkane, and a C₃-C₆ cycloalkane; and
wherein amounts of the fluorocyclopentane, t-DCE, and the organic compound in the nonflammable composition are selected so that the composition is an azeotrope or is azeotrope-like.

20. A method of depositing a material on a substrate, comprising:
dissolving the material in the nonflammable solvent composition according to claim 19;
applying the composition containing the material to the substrate; and
evaporating the composition from the substrate.
